(19) United States
(12) Patent Application Publication
(10) Pub. No.: US 2013/0340589 A1
(43) Pub. Date: Dec. 26, 2013

(54) MANUFACTURING DEVICE AND METHOD OF LIQUID CRYSTAL PANEL

(71) Applicants: Haiwei Pan, Shenzhen (CN); Shengpeng Mo, Shenzhen (CN)

(72) Inventors: Haiwei Pan, Shenzhen (CN); Shengpeng Mo, Shenzhen (CN)

(73) Assignee: Shenzhen China Star Optoelectronics Technology Co., Ltd., Shenzhen (CN)

(21) Appl. No.: 13/641,869

(22) PCT Filed: Jul. 3, 2012
(86) PCT No.: PCT/CN12/78086

§ 371 Date: Oct. 17, 2012

(30) Foreign Application Priority Data
Jun. 20, 2012 (CN) 201210204614.2

(51) Int. Cl. G02F 1/13; B26D 3/00

(52) U.S. Cl. CPC G02F 1/1303; B26D 3/00
USPC 83/861

(57) ABSTRACT

The present disclosure provides a manufacturing device and manufacturing method of a liquid crystal panel. The manufacturing device includes a cutting device for cutting a split plate of a CF substrate of the liquid crystal panel to reveal terminals of a TFT transistor substrate of the liquid crystal panel; a cutting detecting device for detecting cutting state of the split plate and outputting the detecting result; and a first transferring device for receiving the detecting result and operating according to the detecting result. The cutting detecting device detects the cutting state of the liquid crystal panel cut by the cutting device and outputs the detected cutting state to the first transferring device, which prevents the liquid crystal panel with the remained split plate from being transferred to the LC alignment device and avoids the undesirable alignment of the CF substrate and the waste of the liquid crystal panel.

### BACKGROUND

1. Technical Field

The present disclosure relates to liquid crystal displaying technologies and, particularly, to a manufacturing device and a manufacturing method of a liquid crystal panel.

2. Description of Related Art

In a polymer sustained vertical alignment (PSVA) type liquid crystal display (LCD), a liquid crystal panel often includes a color filter (CF) substrate, a TFT (TFT) substrate, and a liquid crystal layer sandwiched between the CF substrate and the TFT substrate. Two transparent conduction layers are respectively disposed on the CF substrate and the TFT substrate. The liquid crystal layer includes a number of monomers. When a voltage is applied to the liquid crystal panel and the liquid crystal panel is irradiated by ultraviolet light, the monomers react to cause liquid crystal molecules to be pre-tilt and thus finish the liquid crystal alignment.

Nowadays, the PSVA type of liquid crystal panel has been commonly used in the TFT-LCD industry. As shown in FIG. 1, in order to apply the voltage to the liquid crystal panel, a split plate 101 of an edge of the CF substrate 10 is cut off by a veneer-cutting machine to reveal terminals 201 to which the voltage is applied. However, the veneer-cutting machine may be abnormal and cannot cut off the split plate 101 completely. In this state, some parts of the split plate 101 may be remained on the edge of the CF substrate 10, which may cover the terminals 201 of the TFT substrate 20. If the parts of the split plate 101 on the edge of the CF substrate 10 are not discovered, the voltage is prevented from being applied to some parts of the liquid crystal panel, which causes the undesirable alignment of the liquid crystal panel and further causes the liquid crystal panel to be abandoned. Additionally, the remained parts of the split plate 101 may damage the probe used for applying the voltage to the liquid crystal panel.

### SUMMARY

The present disclosure provides a manufacturing device of a liquid crystal panel. The liquid crystal panel includes a CF substrate and a TFT substrate. The TFT substrate includes terminals and the CF substrate includes a split plate covering the TFT substrate. The manufacturing device includes a cutting device for cutting the split plate of a color filter (CF) substrate to reveal the terminals of the TFT substrate; a cutting detecting device for detecting cutting state of the split plate and outputting corresponding detecting result; and a first transferring device for receiving the detecting result and operating according to the detecting result; the first transferring device outputting warning signals and a request of determining the cutting state of the split plate if the detecting result indicates that the split plate of the CF substrate is not completely cut off; the first transferring device further operating according to a corresponding feedback operating command.

Preferably, the manufacturing device further includes a liquid crystal alignment device for implementing a liquid crystal alignment process of the liquid crystal panel; if the operating command received by the first transferring device indicates that the cutting state of the split plate of the CF substrate is normal, the first transferring device transfers the liquid crystal panel to the liquid crystal alignment device according to the operating command; if the operating command received by the first transferring device indicates that the cutting state of the split plate was abnormal and the abnormality is eliminated, the first transferring device makes a special mark on the liquid crystal panel and further transfers the liquid crystal panel to the liquid crystal alignment device; if the operating command received by the first transferring device indicates that the cutting state of the split plate was abnormal and the abnormality is still there, and the first transferring device transfers the liquid crystal panel to a liquid crystal panel temporary storage area allowing for a second cutting operation thereto according to the operating command.

Preferably, the manufacturing device further includes an alignment detecting device and a second transferring device, the alignment detecting device is used for detecting the alignment state of the liquid crystal panel after the liquid crystal alignment process is finished and outputting corresponding detecting result to the second transferring device; the second transferring device operates according to the detecting result from the alignment detecting device.

Preferably, if the detecting result received by the second transferring device from the alignment detecting device indicates that the alignment state of the liquid crystal panel is qualified, the second transferring device transfers the liquid crystal panel to allow for implementations of following manufacturing processes; if the detecting result received by the second transferring device from the alignment detecting device indicates that the alignment state of the liquid crystal panel is unqualified, the second transferring device transfers the liquid crystal panel to a first temporary storage area.

Preferably, the liquid crystal alignment device includes a voltage applier for applying a voltage to the liquid crystal panel and an ultraviolet light source for giving out light for irradiating the liquid crystal panel.

The present disclosure further provides another manufacturing device of a liquid crystal panel. The liquid crystal panel includes a TFT substrate having terminals and a CF substrate having a split plate covering the terminals. The manufacturing device includes a cutting device for cutting the split plate of a CF substrate to reveal the terminals of the TFT substrate; a cutting detecting device for detecting cutting state of the split plate and outputting corresponding detecting result; and a first transferring device for receiving the detecting result and operating according to the detecting result.

Preferably, the manufacturing device further includes a liquid crystal alignment device for implementing a liquid crystal alignment process of the liquid crystal panel; and the first transferring device transfers the liquid crystal panel to the liquid crystal alignment device if the received detecting result indicates that the split plate of the CF substrate is completely cut off.

Preferably, the manufacturing device further includes an alignment detecting device and a second transferring device, the alignment detecting device is used for detecting the alignment state of the liquid crystal panel after the liquid crystal alignment process and outputting the detecting result to the second transferring device; and the second transferring device receives the detecting result and operates according to the detecting result.

Preferably, if the detecting result received by the second transferring device from the alignment detecting device indicates that the alignment state of the liquid crystal panel is qualified, the second transferring device transfers the liquid crystal panel to allow for implementations of following manufacturing processes; if the detecting result received by the second transferring device from the alignment detecting device indicates that the alignment state of the liquid crystal panel is unqualified, the second transferring device transfers the liquid crystal panel to a first temporary storage area.

Preferably, the liquid crystal alignment device includes a voltage applier for applying a voltage to the liquid crystal panel and an ultraviolet light source for giving out light for irradiating the liquid crystal panel.

The present disclosure further provides a manufacturing method of a liquid crystal panel. The manufacturing method includes: providing a cutting device for cutting a split plate of a CF substrate of a liquid crystal panel, and providing a cutting detecting device for detecting cutting state of the split plate of the CF substrate and outputting corresponding detecting result; and providing a first transferring device for receiving the liquid crystal panel and the detecting result from the cutting detecting device, and operating according to the detecting result.

Preferably, the step of providing a first transferring device for receiving the liquid crystal panel and the detecting result from the cutting detecting device, and operating according to the detecting result includes:

if the detecting result received by the first transferring device indicates that the split plate of the CF substrate is completely cut off, the first transferring device transfers the liquid crystal panel to the liquid crystal alignment device to allow the liquid crystal alignment device to implement the liquid crystal alignment process of the liquid crystal panel;

if the detecting result received by the first transferring device indicates that the split plate of the CF substrate is not completely cut off, the first transferring device outputs warning signals and a request of determining the cutting state of the split plate; the first transferring device further operates according to corresponding feedback operating command.

Preferably, the step of the first transferring device operates according to corresponding feedback operating command includes:

if the operating command received by the first transferring device indicates that the cutting state of the split plate of the CF substrate is normal, the first transferring device transfers the liquid crystal panel to the liquid crystal alignment device according to the operating command;

if the operating command received by the first transferring device indicates that the cutting state of the split plate was abnormal and the abnormality is eliminated, the first transferring device makes a special mark on the liquid crystal panel and further transfers the liquid crystal panel to the liquid crystal alignment device; and

if the operating command received by the first transferring device indicates that the cutting state of the split plate was abnormal and the abnormality is still there, the first transferring device transfers the liquid crystal panel to a liquid crystal panel temporary storage area allowing for a second cutting operation thereof according to the operating command.

Preferably, the step of the first transferring device transfers the liquid crystal panel to the liquid crystal alignment device includes:

the liquid crystal alignment detecting device detects the alignment state of the liquid crystal panel and outputs the detecting result to the second transferring device; and

the second transferring device receives the detecting result and operates according to the received detecting result.

Preferably, the step of the second transferring device operates according to the received detecting result includes:

if the detecting result received by the second transferring device indicates that the alignment state of the liquid crystal panel is qualified, the second transferring device transfers the liquid crystal panel to allow for implementations of following manufacturing processes; and

if the detecting result received by the second transferring device indicates that the alignment state of the liquid crystal panel is unqualified, the second transferring device transfers the liquid crystal panel to a first temporary storage area.

In the manufacturing device and manufacturing method of the present disclosure, the cutting detecting device is capable of detecting the cutting state of the liquid crystal panel cut by the cutting device and outputting the detected cutting state to the first transferring device, which prevents the liquid crystal panel with the remained split plate from being transferred to the LC alignment device. This can further prevent the undesirable alignment of the CF substrate caused by the remained split plate and the waste of the liquid crystal panel, improve the yield rate of the liquid crystal panel, and prevent the probe from being damaged by the voltage applier.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view showing the present cutting process of a split plate of CF substrate of a liquid crystal panel;

FIG. 2 is a schematic view of a manufacturing device of the liquid crystal panel in accordance with an embodiment of the present disclosure;

FIG. 3 is a flow chart of a manufacturing method of the liquid crystal panel;

FIG. 4 is a flow chart of the step of providing a first transferring device for receiving the liquid crystal panel and the detecting result, and operating according to the detecting result.

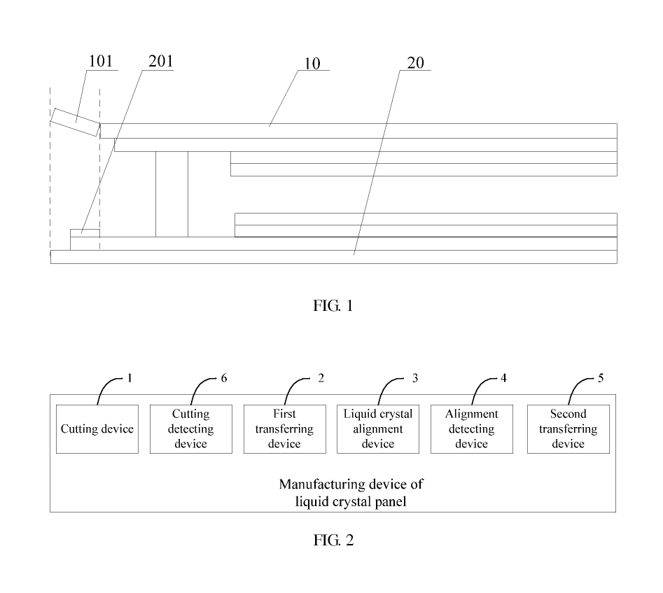

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

Referring to FIG. 2, which is a schematic view of a manufacturing device of the liquid crystal panel in accordance with an embodiment of the present disclosure.

A manufacturing device of a liquid crystal panel in accordance with the embodiment includes a cutting device 1, a cutting detecting device 6, a liquid crystal (LC) alignment device 3, a first transferring device 2, an alignment detecting device 4, and a second transferring device 5.

The liquid crystal panel includes a color filter (CF) substrate, a thin film transistor (TFT) substrate, and a liquid crystal layer sandwiched between the CF substrate and the TFT substrate. Edges of the TFT substrate are provided with terminals for applying a voltage thereonto. The liquid crystal layer includes a number of reactive monomers, and the CF substrate includes a split plate covering the terminals of the TFT substrate.

The cutting device 1 is used for processing an edge of the CF substrate and cutting off the split plate to reveal the terminals of the TFT substrate.

The cutting detecting device 6 is used for detecting the cutting state of the split plate of the CF substrate, that is, for detecting whether the split plate is completely cut off or not. The detecting result is capable of showing that the split plate is completely cut off or not. The cutting detecting device 6 further outputs the detecting result to the first transferring device 2. In some embodiments, the cutting detecting device 6 can be disposed on the cutting device 1. In other embodiments, the cutting detecting device 6 can be disposed separately from the cutting device 1 and can be a defect imaging camera.

The first transferring device 2 receives the liquid crystal panel and the detecting result outputted from the cutting detecting device 6, and operates according to the received detecting result.

When the detecting result received by the first transferring device 2 indicates that the split plate is completely cut off, the first transferring device 2 transfers the liquid crystal panel to the LC alignment device 3. The LC alignment device 3 then implements the LC alignment process of the liquid crystal panel. The LC alignment device 3 includes a voltage applier for applying the voltage to the liquid crystal panel and an ultraviolet light source for giving out light for irradiating the liquid crystal panel. When the voltage applier is applying the voltage to the liquid crystal panel, the ultraviolet light source irradiates the liquid crystal panel at the same time to allow the monomers in the liquid crystal layer to react. Thus, the liquid crystal molecules can be pre-tilt to finish the LC alignment process.

If the detecting result received by the first transferring device 2 indicates that the split plate of the CF substrate is not completely cut off, the first transferring device 2 outputs warning signals and a request of determining the cutting state of the split plate of the CF substrate. The cutting state of the split plate is determined according to the request from the first transferring device 2 and a corresponding operating command is feedbacked to the first transferring device 2. The first transferring device 2 receives the operating command and operates accordingly, which is given in detail in the following description:

If the operating command received by the first transferring device 2 indicates that the cutting state of the split plate is normal, that is, the split plate is completely cut off, the first transferring device 2 transfers the liquid crystal panel to the LC alignment device 3 according to the received operating command.

If the operating command received by the first transferring device 2 indicates that the cutting state of the split plate was abnormal and the abnormality has been already eliminated, for example, a small part of the split plate was remained on the CF substrate and has been cut off from the CF substrate, the first transferring device 2 makes a special mark on the liquid crystal panel according to the operating command and transfers the liquid crystal panel to the LC alignment device 3, which allows for the implementation of the LC alignment process.

If the operating command received by the first transferring device 2 indicates that the cutting state of the split plate is abnormal and the abnormality is still there, for example, a small part of the split plate is still remained on the CF substrate. The first transferring device 2 transfers the liquid crystal panel to a liquid crystal panel temporary storage area allowing for a second cutting operation thereof according to the operating command. The first transferring device 2 further transfers the liquid crystal panel in the liquid crystal panel temporary storage area to the cutting device 1 allowing for the second cutting operation. If the liquid crystal panel is detected to be qualified after the second cutting operation, the first transferring device 2 transfers the qualified liquid crystal panel to the LC alignment device 3, which allows for the implementation of the LC alignment process. Meanwhile, the first transferring device 2 makes a special mark on the liquid crystal panel.

The alignment detecting device 4 detects the alignment state of the liquid crystal panel after the LC alignment process. That is, the alignment detecting device 4 determines the alignment state of the liquid crystal panel is qualified or not and outputs the detecting result to the second transferring device 5. The second transferring device 5 receives the detecting result from the alignment detecting device 4 and operates accordingly. If the detecting result received by the second transferring device 5 indicates that the alignment state of the liquid crystal panel is qualified, the second transferring device 5 transfers the liquid crystal panel to allow for implementations of following manufacturing processes. If the detecting result received by the second transferring device 5 indicates that the alignment state of the liquid crystal panel is unqualified, the second transferring device transfers the liquid crystal panel to a first temporary storage area.

In the manufacturing device of the present disclosure, the cutting detecting device 6 is capable of detecting the cutting state of the liquid crystal panel cut by the cutting device 1 and outputting the detected cutting state to the first transferring device 2, which prevents the liquid crystal panel with the remained split plate from being transferred to the LC alignment device 3. This can further prevent the undesirable alignment of the liquid crystal panel caused by the incompletely cut of the split plate of CF substrate, and the waste of the liquid crystal panel, improve the yield rate of the liquid crystal panel, and prevent the probe of the voltage applier of the LC alignment dev ice 3 from being damaged. Additionally, second cutting operation is carried out to the liquid crystal panel with the remained split plate to improve the utilization rate of the liquid crystal panel.

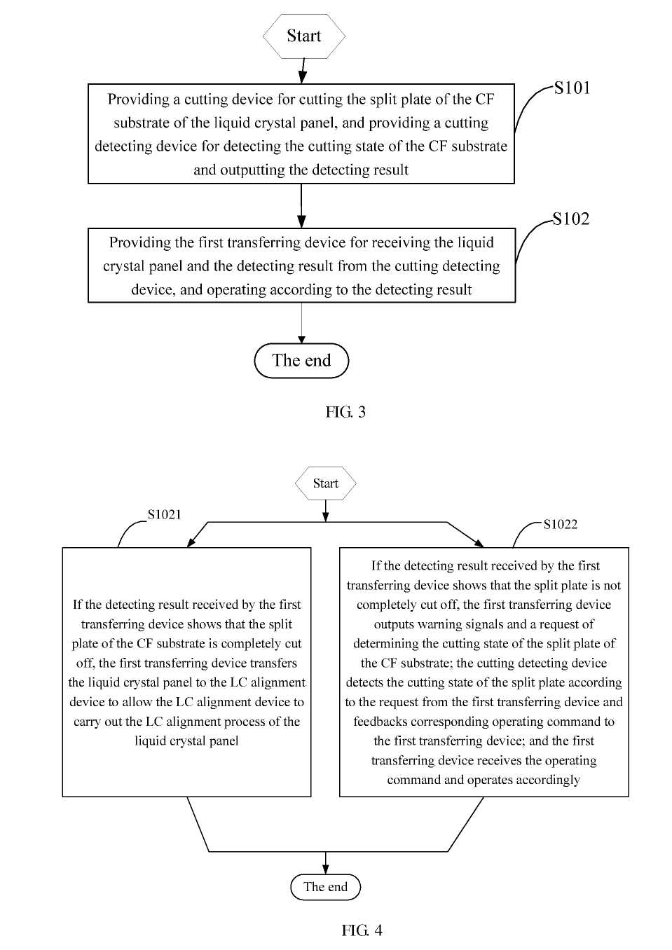

Referring to FIG. 3, the present disclosure further provides a manufacturing method of the liquid crystal panel which can be employed in the above manufacturing device. The manufacturing method includes:

Step S101, providing a cutting device 1 for cutting the split plate of the CF substrate of the liquid crystal panel, and providing a cutting detecting device 6 for detecting the cutting state of the CF substrate and outputting the detecting result.

With the cutting device 1, the split plate on the edge of the CF substrate is cut off to reveal terminals corresponding to the TFT substrate. The cutting detecting device 6 detects the cutting state of the CF substrate to determine whether the split plate is completely cut off or not and outputs the detecting result. The detecting result is capable of showing that the split plate is completely cut off or not.

After the cutting device 1 finishes cutting process, the liquid crystal panel is transferred to a first transferring device 2. Meanwhile, the cutting detecting device 6 outputs the detecting result to the first transferring device 2.

Step S102, providing the first transferring device 2 for receiving the liquid crystal panel and the detecting result from the cutting detecting device 6, and operating according to the detecting result. As shown in FIG. 4, the step S102 specifically includes:

Step S1021, if the detecting result received by the first transferring device 2 indicates that the split plate of the CF substrate is completely cut off, the first transferring device 2 transfers the liquid crystal panel to the LC alignment device 3 to allow the LC alignment device 3 to carry out the LC alignment process. The LC alignment device 3 includes a voltage applier for applying the voltage to the liquid crystal panel and an ultraviolet light source for giving out light for irradiating the liquid crystal panel. When the voltage applier applies the voltage to the terminals of the TFT substrate, the ultraviolet light source irradiates the liquid crystal panel at the same time to allow the monomers of the liquid crystal layer to react. Thus, the liquid crystal molecules can be pre-tilt to finish the liquid crystal alignment of the liquid crystal panel.

Step S1022, if the detecting result received by the first transferring device 2 indicates that the split plate is not completely cut off, the first transferring device 2 outputs warning signals and a request of determining the cutting state of the split plate of the CF substrate; the cutting state of the split plate is detected according to the request from the first transferring device 2 and a corresponding operating command is feedbacked to the first transferring device 2; and the first transferring device 2 receives the operating command and operates accordingly, which is given in detail in the following description:

If the operating command received by the first transferring device 2 indicates that the cutting state of the split plate is normal, that is, the split plate of the CF substrate is completely cut off, the first transferring device 2 transfers the liquid crystal panel to the LC alignment device 3 for carrying out the LC alignment process according to the operating command. The second transferring device 5 transfers the liquid crystal panel to allow for implementations of following manufacturing processes.

If the operating command received by the first transferring device 2 indicates that the cutting state of the split plate was abnormal and the abnormality has been already eliminated, for example, a small part of the split plate of the CF substrate was remained on the CF substrate but is already cut off, the first transferring device 2 makes a special mark on the liquid crystal panel according to the received operating command. Meanwhile, the first transferring device 2 transfers the liquid crystal panel to the LC alignment device 3 for carrying out the LC alignment process. After the LC alignment process is finished, the alignment device 4 detects the alignment state of the liquid crystal panel to determine the alignment state of the liquid crystal panel is qualified or not, and outputs the detecting result to the second transferring device 5. The second transferring device 5 receives the detecting result from the alignment detecting device 4 and operates accordingly. If the detecting result received by the second transferring device 5 indicates that the alignment state of the liquid crystal panel is qualified, the second transferring device 5 transfers the liquid crystal panel to allow for implementations of following manufacturing processes. If the detecting result received by the second transferring device 5 indicates that the alignment state of the liquid crystal panel is unqualified, the second transferring device 5 transfers the liquid crystal panel to a first temporary storage area.

If the operating command received by the first transferring device 2 indicates that the cutting state of the split plate is abnormal and the abnormality is still there, for example, a small part of the split plate is still remained on the CF substrate, the first transferring device 2 transfers the liquid crystal panel to a liquid crystal panel temporary storage area allowing for a second cutting operation thereto according to the operating command. The first transferring device 2 further transfers the liquid crystal panel in the liquid crystal panel temporary storage area to the cutting device 1 for carrying out the second cutting operation, and the manufacturing device 2 processes the step S101 to the step S102.

In the manufacturing device and manufacturing method of the liquid crystal panel according to the present disclosure, the cutting detecting device 6 is capable of detecting the cutting state of the liquid crystal panel cut by the cutting device 1 and outputting the detected cutting state to the first transferring device 2, which prevents the liquid crystal panel with the remained split plate from being transferred to the LC alignment device 3. This can further prevent the undesirable alignment of the liquid crystal panel caused by the remained split plate of the CF substrate and the waste of the liquid crystal panel, improve the yield rate of the liquid crystal panel, and prevent the probe of the voltage applier of the LC alignment device 3 from being damaged. Additionally, second cutting operation is carried out to the liquid crystal panel with the remained split plate to improve the utilization rate of the panel.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A manufacturing device of a liquid crystal panel, the liquid crystal panel comprising a CF substrate and a TFT substrate, wherein the TFT substrate includes terminals and the CF substrate includes a split plate covering the terminals, characterized in that: the manufacturing device comprises:
a cutting device for cutting the split plate of the CF substrate to reveal the terminals of the TFT substrate;
a cutting detecting device for detecting cutting state of the split plate and outputting detecting result; and
a first transferring device for receiving the detecting result and operating according to the detecting result; the first transferring device outputting warning signals and a request of determining the cutting state of the split plate if the detecting result indicates that the split plate of the CF substrate is not completely cut off; the first transferring device further operating according to a corresponding feedback operating command.

2. The manufacturing device as claimed in claim 1 further comprising a liquid crystal alignment device for implementing liquid crystal alignment process of the liquid crystal panel;
if the operating command received by the first transferring device indicates that the cutting state of the split plate of the CF substrate is normal, the first transferring device transfers the liquid crystal panel to the liquid crystal alignment device according to the operating command;
if the operating command received by the first transferring device indicates that the cutting state of the split plate was abnormal and the abnormality is eliminated, the first transferring device makes a special mark on the liquid crystal panel and further transfers the liquid crystal panel to the liquid crystal alignment device;
if the operating command received by the first transferring device indicates that the cutting state of the split plate was abnormal and the abnormality is still there, and the first transferring device transfers the liquid crystal panel to a liquid crystal panel temporary storage area allowing for a second cutting operation thereto according to the operating command.

3. The manufacturing device as claimed in claim 2 further comprising an alignment detecting device and a second transferring device, the alignment detecting device is used for detecting the alignment state of the liquid crystal panel after the liquid crystal alignment process is finished and outputting corresponding detecting result to the second transferring device; the second transferring device operates according to the detecting result from the alignment detecting device.

4. The manufacturing device as claimed in claim 3, wherein if the detecting result received by the second transferring device from the alignment detecting device indicates that the alignment state of the liquid crystal panel is qualified, the second transferring device transfers the liquid crystal panel to allow for implementations of following manufacturing processes; if the detecting result received by the second transferring device from the alignment detecting device indicates that the alignment state of the liquid crystal panel is unqualified, the second transferring device transfers the liquid crystal panel to a first temporary storage area.

5. The manufacturing device as claimed in claim 2, wherein the liquid crystal alignment device comprises a voltage applier for applying a voltage to the liquid crystal panel and an ultraviolet light source for giving out light for irradiating the liquid crystal panel.

6. A manufacturing device of a liquid crystal panel, the liquid crystal panel comprising a TFT substrate having terminals and a CF substrate having a split plate covering the terminals, wherein manufacturing device comprises:
a cutting device for cutting the split plate of a CF substrate to reveal the terminals of a TFT substrate of the liquid crystal panel;
a cutting detecting device for detecting cutting state of the split plate and outputting corresponding detecting result; and
a first transferring device for receiving the detecting result and operating according to the detecting result.

7. The manufacturing device as claimed in claim 6 further comprising a liquid crystal alignment device for implementing a liquid crystal alignment process of the liquid crystal panel; and the first transferring device transfers the liquid crystal panel to the liquid crystal alignment device if the received detecting result indicates that the split plate of the CF substrate is completely cut off.

8. The manufacturing device as claimed in claim 7 further comprising an alignment detecting device and a second transferring device, the alignment detecting device is used for detecting the alignment state of the liquid crystal panel after the liquid crystal alignment process and outputting the detecting result to the second transferring device; and the second transferring device receives the detecting result and operates according to the detecting result.

9. The manufacturing method as claimed in claim 8, wherein if the detecting result received by the second transferring device from the alignment detecting device indicates that the alignment state of the liquid crystal panel is qualified, the second transferring device transfers the liquid crystal panel to allow for the implementation of following manufacturing processes; if the detecting result received by the second transferring device from the alignment detecting device indicates that the alignment state of the liquid crystal panel is unqualified, the second transferring device transfers the liquid crystal panel to a first temporary storage area.

10. The manufacturing device as claimed in claim 7, wherein the liquid crystal alignment device comprises a voltage applier for applying a voltage to the liquid crystal panel and an ultraviolet light source for giving out light for irradiating the liquid crystal panel.

11. A manufacturing method of a liquid crystal panel, comprising:
providing a cutting device for cutting a split plate of a CF substrate of the liquid crystal panel and providing a cutting detecting device for detecting cutting state of the split plate of the CF substrate and outputting a corresponding detecting result; and
providing a first transferring device for receiving the liquid crystal panel and the detecting result from the cutting detecting device and operating according to the detecting result.

12. The manufacturing method as claimed in claim 11, wherein the step of providing a first transferring device for receiving the liquid crystal panel and the detecting result from the cutting detecting device and operating according to the detecting result comprises:
if the detecting result received by the first transferring device indicates that the split plate of the CF substrate is completely cut off, the first transferring device transfers the liquid crystal panel to the liquid crystal alignment device to allow the liquid crystal alignment device to implement the liquid crystal alignment process to the liquid crystal panel; and
if the detecting result received by the first transferring device indicates that the split plate of the CF substrate is not completely cut off, the first transferring device outputs warning signals and a request of determining the cutting state of the split plate;
the first transferring device further operates according to corresponding feedback operating command.

13. The manufacturing method as claimed in claim 12, wherein the step of the first transferring device operates according to corresponding feedback operating command comprises:
if the operating command received by the first transferring device indicates that the cutting state of the split plate of the CF substrate is normal, the first transferring device transfers the liquid crystal panel to the liquid crystal alignment device according to the operating command;
if the operating command received by the first transferring device indicates that the cutting state of the split plate was abnormal and the abnormality is eliminated, the first transferring device makes a special mark on the liquid crystal panel and further transfers the liquid crystal panel to the liquid crystal alignment device; and
if the operating command received by the first transferring device indicates that the cutting state of the split plate was abnormal and the abnormality is still there, the first transferring device transfers the liquid crystal panel to a liquid crystal panel temporary storage area allowing for a second cutting operation thereof according to the operating command.

14. The manufacturing method as claimed in claim 13, wherein the step of the first transferring device transfers the liquid crystal panel to the liquid crystal alignment device comprises:
the liquid crystal alignment detecting device detects the alignment state of the liquid crystal panel and outputs the detecting result to the second transferring device; and
the second transferring device receives the detecting result and operates according to the received detecting result.

15. The manufacturing method as claimed in claim 14, wherein the step of the second transferring device operates according to the received detecting result comprises:
if the detecting result received by the second transferring device indicates that the alignment state of the liquid crystal panel is qualified, the second transferring device transfers the liquid crystal panel to allow for implementations of following manufacturing processes; and
if the detecting result received by the second transferring device indicates that the alignment state of the liquid crystal panel is unqualified, the second transferring device transfers the liquid crystal panel to a first temporary storage area.
